(19) United States
(12) Patent Application Publication
(10) Pub. No.: US 2004/0028023 A1
(43) Pub. Date: Feb. 12, 2004

(54) Method and apparatus for providing ad-hoc networked sensors and protocols

(75) Inventors: Indur B. Mandhyan, Princeton, NJ (US); Paul Hashfield, Princeton Junction, NJ (US); Alaattin Caliskan, Lawrenceville, NJ (US); Robert Siracusa, Lawrenceville, NJ (US)

Correspondence Address: MOSER, PATTERSON & SHERIDAN, LLP, /SARNOFF CORPORATION, 595 SHREWSBURY AVENUE, SUITE 100, SHREWSBURY, NJ, 07702, US

(73) Assignee: Sarnoff Corporation

(21) Appl. No.: 10/419,044

(22) Filed: Apr. 18, 2003

Related U.S. Application Data
(60) Provisional application No. 60/373,544, filed on Apr. 18, 2002.

(51) Int. Cl. H04L 12/28

(52) U.S. Cl. 370/351

(57) ABSTRACT

A system, apparatus and method for providing an ad-hoc network of sensors. More specifically, the ad-hoc networked sensor system is based on novel network protocols that produce a self-organizing and self-healing network.

This application claims the benefit of U.S. Provisional Application No. 60/373,544 filed on Apr. 18, 2002, which is herein incorporated by reference.

This invention was made with U.S. government support under contract number DAAB 07-01-9-L504. The U.S. government has certain rights in this invention.

The present invention relates to an architecture and protocols for a network of sensors. More specifically, the present invention provides a network of sensors with network protocols that produce a self-organizing and self-healing network.

### BACKGROUND OF THE DISCLOSURE

Many devices can be networked together to form a network. However, it is often necessary to configure such network manually to inform a network controller of the addition, deletion, and/or failure of a networked device. This results in a complex configuration procedure that must be executed during the installation of a networked device, thereby requiring a skilled technician.

In fact, it is often necessary for the networked devices to continually report its status to and from the network controller. Such network approach is cumbersome and inflexible in that it requires continuous monitoring and feedback between the networked devices and the network controller. It also translates into a higher power requirement, since the networked devices are required to continually report to the network controller even when no data is being passed to the network controller.

Additionally, if a networked device or the network controller fails or is physically relocated, it is often necessary to again manually reconfigure the network so that the failed network device is identified and new routes have to be defined to account for the loss of the networked device or the relocation of the network controller. Such manual reconfiguration is labor intensive and reveals the inflexibility of such network.

Therefore, there is a need for a network architecture and protocols that will produce a self-organizing and self-healing network.

### SUMMARY OF THE INVENTION

In one embodiment, the present invention is a system, apparatus and method for providing an ad-hoc network of sensors. More specifically, the ad-hoc networked sensor system is based on novel network protocols that produce a self-organizing and self-healing network.

One key component of the system is an intelligent sensor node that interfaces with sensors (e.g., on-board or external) to detect sensor events that can be reported to a control node. In one embodiment, the sensor node may optionally employ low cost wireless interfaces. Each intelligent sensor node can simultaneously monitor multiple sensors, either internal sensors or attached sensors or both. Networking software is modular and independent of the communications interface, e.g., Bluetooth, IEEE 802.11 and the like.

More importantly, the present network automatically determines optimum routes for network traffic and finds alternate routes when problems are encountered. Some of the benefits of the present architecture include simplicity in the initial deployment of a sensor network, no requirements for skilled network technicians, extending the range of a control node, and the ability to leverage the rapidly growing emerging market in low power wireless devices.

### BRIEF DESCRIPTION OF THE DRAWINGS

The teachings of the present invention can be readily understood by considering the following detailed description in conjunction with the accompanying drawings, in which:

FIG. 1 illustrates a diagram of the sensor network of the present invention;

FIG. 2 illustrates a flowchart of a method for deploying consumer nodes of the present invention;

FIG. 3 illustrates a flowchart of a method for deploying producer nodes of the present invention;

FIG. 4 illustrates a flowchart of a method for deploying a control node of the present invention;

FIG. 5 illustrates a flowchart of a method for operating a control node of the present invention;

FIG. 6 illustrates a flowchart of a method for operating a sensor node of the present invention; and

FIG. 7 illustrates a block diagram of a general purpose computer system implementing a network node of the present invention.

To facilitate understanding, identical reference numerals have been used, where possible, to designate identical elements that are common to the figures.

### DETAILED DESCRIPTION

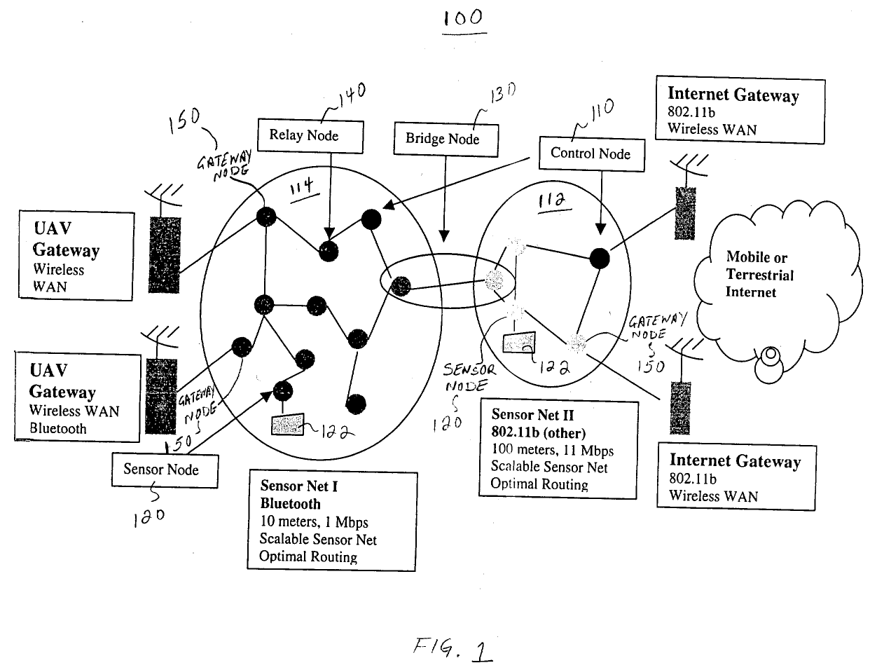

FIG. 1 illustrates a diagram of the sensor network or system 100 of the present invention. The present invention provides a plurality of nodes that operate cooperatively to form the ad-hoc networked sensor system. These nodes include control node 110, sensor node 120, bridge node 130, relay node 140 and gateway node 150. Each type of these nodes has different capabilities and these capabilities are further disclosed below. It should be noted that the present system can be implemented with one or more of each type of nodes. In fact, depending on the particular implementation, some of these nodes can even be omitted.

The basic function of the sensor network 100 is to collect sensor measurements and to route the sensor data to an appropriate end node for further processing, e.g., to a control node 110 or to a control node (not shown) on the receiving end of a gateway node 150. One important advantage of the present invention is that the sensor network 100 will be deployed in an arbitrary manner and it will establish the necessary communication, routing and configuration mechanisms automatically without human intervention. Namely, the sensor network will be self-organizing, thereby allowing for easy, rapid deployment that does not require specific placement of the nodes or extensive pre-configuration or network management activities. With this novel feature, the sensor network can be adapted to complex military and commercial environments and/or implementations where the network configuration changes dynamically due to nodes being added or subtracted from the network.

The five (5) types of logical nodes in the sensor network 100 will now be distinguished based upon the functions that they performed.

Sensor nodes 120 will be directly responsible for interfacing with one or more sensors 122 and for routing the sensor data toward the control nodes 110, bridge nodes 130 and gateway nodes 150. A sensor node may maintain a record of the operating characteristics of the control node(s). For example, it may maintain the identity of the control node(s) and estimate of the round trip delay from the sensor node to the control node(s).

Additionally, the sensor nodes as described in the present invention may provide a standards-conforming interface(s) for capturing information from attached/integrated sensors. This interface(s) should support multiple sensor types including current commercially available sensors and possible future military specific sensors.

Relay nodes 140 will be primarily responsible for routing sensor data received from other nodes to control, gateway or bridge nodes. In fact, sensor node can also serve as a relay node.

Control nodes 110 are designed to receive sensor data from relay or sensor nodes. Typically, control nodes will be final or ultimate nodes in a sequence of nodes along which sensor data has traversed. Control nodes may have the capability to set and get sensor node parameters. Control nodes may use the data obtained from sensor nodes to build and store a map of the deployed sensor nodes. Control nodes may also maintain a record of the operating characteristics of each sensor node. For example, it may maintain the identity of each sensor node, the type of the sensor (acoustic or seismic, etc.), the mean time between messages received and an estimate of the round trip delay from the control node to the sensor node.

Bridge nodes 130 are designed to receive sensor data from control, relay or sensor nodes. Bridge nodes will be equipped with multiple wireless interfaces for transmitting sensor data from a low bandwidth network (or subnetwork) 114 to a higher bandwidth network (or sub-network) 112. Bridge nodes will be capable of routing the received data to control, bridge nodes or gateways in the higher bandwidth network.

Gateway nodes 150 are designed to interface with external networks. Examples of such external networks include but are not limited to the Tactical Internet via private terrestrial, cellular networks, or any wired or wireless networks.

The control, bridge and gateway nodes can be broadly perceived as “consumer nodes” and the sensor and relay nodes can be broadly perceived as “producer nodes”. Namely, the sensor and relay nodes provide or produce sensor data, whereas the control, bridge and gateway nodes receive or consume sensor data. Thus, producer nodes will generate sensor data in a synchronous or asynchronous manner, whereas the consumer nodes will receive sensor data in a synchronous or asynchronous manner.

All the above nodes or a subset of the above nodes can participate in the present ad-hoc sensor network. Nodes with multiple interfaces will be visible simultaneously in multiple sub-networks. It should be noted that a control node and a gateway node can be coalesced into a single node, e.g., a control node with the capability of the gateway node. Similarly, it should be noted that a sensor node and a relay node (and even a bridge node) can be coalesced into a single node, e.g., a sensor node with the capability of the relay and bridge nodes. Thus, the number of control and gateway nodes in such sensor system is generally small.

Thus, in summary, each of the above nodes may have (some or all of) the following capabilities to:

a. Collect information from one or more attached/integrated sensor(s),

b. Communicate via wireless links with other nodes,

c. Collect information from other nearby nodes,

d. Aggregate multiple sensor information,

e. Relay information on the behalf of other nodes, and

f. Communicate sensor information via a standard router interface with the Internet.

In one embodiment, the present sensor network 100 will primarily be an asynchronous event driven sensor network. That is, sensors 122 will be activated by external events that will occur in an asynchronous manner. Thus, the sensors will typically transmit data asynchronously. However, control nodes may send probe or control data at periodic intervals to set sensor parameters and to assess the state of the network and to establish routing information. Control nodes may also send acknowledgement packets to indicate the receipt of the sensor data. However, it should be noted that the present design can be applied and extended for environments in which sensors generate synchronous data as well.

It should be noted that the present sensor network is designed to account for the mobility of the control, sensor and relay nodes. Although such events may occur minimally, control nodes may change location for tactical reasons (e.g., to maintain security), while sensor or relay nodes may change location due to some external event, such as an inadvertent push by a passing vehicle or person.

The present sensor network is also designed to detect failure and addition of network nodes, thereby allowing the sensor network to adapt to such changes, i.e., self-healing. For example, alternative routes that avoid the malfunctioning or failed nodes can be computed to ensure the delivery of sensor data. Similarly, addition of a new node may trigger the discovery of a new route, thereby allowing sensor data to be transmitted via a shorter route. Nodes may enter or leave the sensor network at any time. Entering the sensor network implies additional node deployment and leaving implies a node removal or failure.

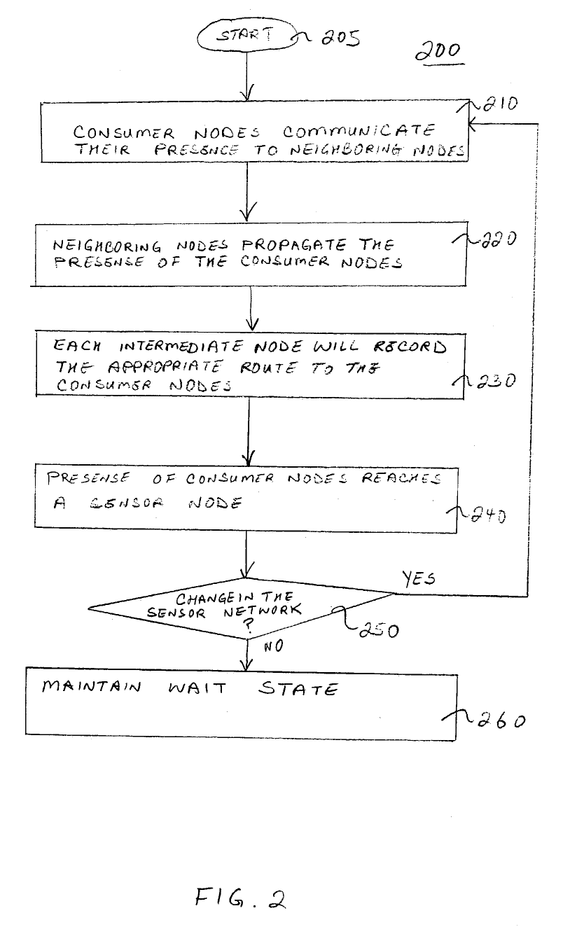

FIG. 2 illustrates a flowchart of a method 200 for deploying consumer nodes of the present invention. In general, all nodes will be deployed in an arbitrary manner. However, consumer nodes (control, bridge and gateway) may be placed in a controlled manner taking into account the terrain and other environmental factors. In some embodiment, upon completion of deployment, an operator action will effect the steps of FIG. 2. However, in other embodiments, no operator action is necessary once the network nodes are deployed, i.e., activated.

Method 200 starts in step 205 and proceeds to step 210. In step 210, upon activation, one or more consumer nodes will communicate or broadcast their presence to neighboring network nodes. For example, a message can be communicated to a neighboring node that is within the broadcasting range of the consumer nodes.

In step 220, neighbors of the consumer nodes receiving the broadcasted message from the consumer nodes will, in turn, communicate the presence of the consumer nodes to their neighbors. Namely, each node has a map stored in its memory of other nodes that are one hop away. Upon receiving the announcement message from the consumer nodes, each node will propagate that message to all its neighboring nodes. This propagation will continue until all sensor nodes within the network are aware of the consumer nodes.

In step 230, during the process of communicating the consumer presence information, i.e., consumer location information, each intermediate node will record the appropriate route (multiple routes are possible) to the consumer node(s). This decentralized updating approach allows scaling of the present sensor system (adding and deleting nodes) to be implemented with relative ease. One simply activates a consumer node within range of another node and the sensor system will incorporate the consumer node into the network and all the nodes in the system will update themselves accordingly.

In step 240, the presence information of the consumer nodes will eventually reach one or more sensor nodes. Sensor nodes will be considered initialized once they are aware of at least one consumer node; that is they have constructed the appropriate route(s) to the consumer node. At this time, sensor nodes may then send a preamble introductory message to the consumer node(s) acknowledging their existence. Appropriate routes (to the sensors) may be recorded by the relay and other nodes as the preamble finds its way to the consumer node(s). Once initialized, sensor nodes may commence transmitting sensor data to the consumer node(s).

In step 250, method 200 queries whether there is a change in the sensor network. If the query is answered positively, then method 200 returns to step 210 where one or more of the consumer nodes will report a change and the entire propagation process with be repeated. If the query is negatively answered, then method 200 proceeds to step 260, where the sensor system remains in a wait state.

More specifically, dynamic changes in the sensor network 100 may occur in many ways. The consumer node may change location or the sensor or relay nodes may change location or both. When a consumer node changes location, the consumer node will announce itself to its neighbors (some new and some old) and re-establishes new routes.

Alternatively, dynamic changes can be detected by the producer nodes. Namely, sensor and relay nodes expect an acknowledgment (ACK) message for every message that is sent to the control node(s). For example, one of the sensors associated with the sensor node may trigger a reportable event. If no ACK message is received, then the relay or sensor node will retransmit the message or will re-establish the piconet (an environment defined as a node's immediate neighbors) under the assumption that there has been a change in the neighborhood structure of the sensor or relay node. Upon re-establishing the piconet, the sensor or relay node will attempt to determine new routes (from its neighbors) to the control node(s).

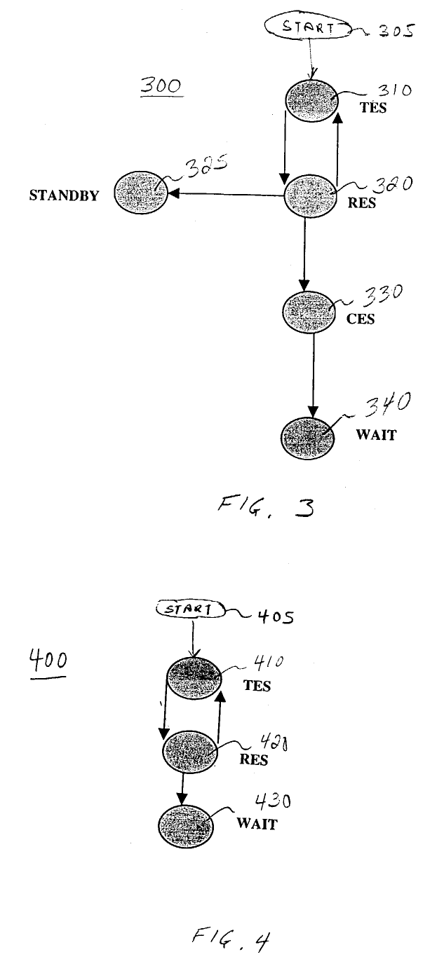

FIG. 3 illustrates a flowchart of a method 300 for deploying producer nodes of the present invention. Namely, FIG. 3 illustrates the deployment of a producer node (sensor node or relay node). Method 300 starts in step 305 and proceeds to step 310.

In step 310, a producer node is activated and it enters into a topology establishment state (TES). Specifically, the sensor node establishes its neighborhood and partakes in the neighborhood of its neighbors. That is, the producer node transits to a state where it will listen to inquiries from its neighbors. Alternatively, the producer node may also attempt to discover its neighbors, by actively broadcasting a message. Thus, in the topology phase all connections are established. The sensor node then moves into the route establishment state (RES) in step 320.

When the sensor node enters the route establishment state in step 320, it queries its neighbors using a route request message for a route to a consumer node, e.g., a control node. A neighboring node that has a route will send a route reply message to the requesting sensor node. Appropriate routing entries are made in the routing table of the requesting sensor node. The sensor node records the current best route to the control node. If there is at least one connected neighbor that does not have a route to the control node, the sensor node may enter the topology establishment phase 310 again. This cycle continues until all neighbors have a route to the control node or after a fixed number of tries.

When the TES-RES cycle terminates, there are two possible outcomes: 1) the sensor node has at least one route to the control node or 2) no route to the control node. In the first case, it enters the credentials establishment state (CES) and in the later case, it enters a low power standby mode in step 325 and may reinitiate the TES-RES cycle at a later time. Note that not all (potential) neighbors of the sensor node may be deployed when the TES-RES cycle terminates. Thus if a node is deployed in the vicinity of the sensor node at a later time, it may not be discovered by the sensor node. However, the potential neighbor will discover the sensor node and request route information from the sensor. The sensor will then originate a route request message to the new neighbor at that time.

After the route establishment state, the sensor moves into the credentials establishment state in step 330. In this state, the sensor node sends information to the control node establishing contact with the control node. The sensor node sends device characteristics such as configurable parameters and power capacity. Note that in this phase, all intermediate nodes that relay sensor credentials to the control node will establish a route from the control node to the sensor node. In particular, the control node has a route to the sensor node. The sensor node now moves into the wait state in step 340, where it is ready to transmit data to the control node.

FIG. 4 illustrates a flowchart of a method 400 for deploying a control node of the present invention. More generally, FIG. 4 illustrates the deployment of a consumer node (control, bridge, or gateway). Method 400 starts in step 405 and proceeds to step 410.

In step 410, a consumer node is activated and it enters into a topology establishment state (TES). Specifically, as disclosed above, the control node attempts to determine its neighborhood and also partake in the neighborhood of its neighbors. All connections are established at this time. The control node then moves into the route establishment state.

In the route establishment state of step 420, the control node will receive a route request message from its neighbors. It replies with a route reply message indicating that it has a zero-hop route to the control node. The node transmits its identity and any relevant information to its neighbors. The neighbors may be sensor nodes, relay nodes, bridge nodes or gateway nodes. Thus, all nodes in the neighborhood of the control node have a single hop route to the control node. The neighbors of the control node can now reply to the route request messages from their neighbors. Since not all sensor/relay nodes may be deployed at the same time, the control node may revert to the topology establishment state at a later time. The TES-RES cycle continues for a fixed number of tries or may be terminated manually. When the TES-RES cycle terminates, all neighboring nodes have a one-hop route to the control node and it is assumed that all nodes have been deployed. However, the TES-RES cycle can be re-initiated and terminated. The control node then moves into the wait state in step 430 after the TES-RES cycle terminates.

It should be noted, that as long as there is no control node deployed in the network, no sensor data will be transmitted. Once a control node is deployed, its presence propagates throughout the network and sensor nodes may begin transmitting sensor data. Note also that valuable battery power may be consumed in the TES-RES cycle. Thus, an appropriate timing period can be established for a particular implementation to minimize the consumption of the battery power of a network node.

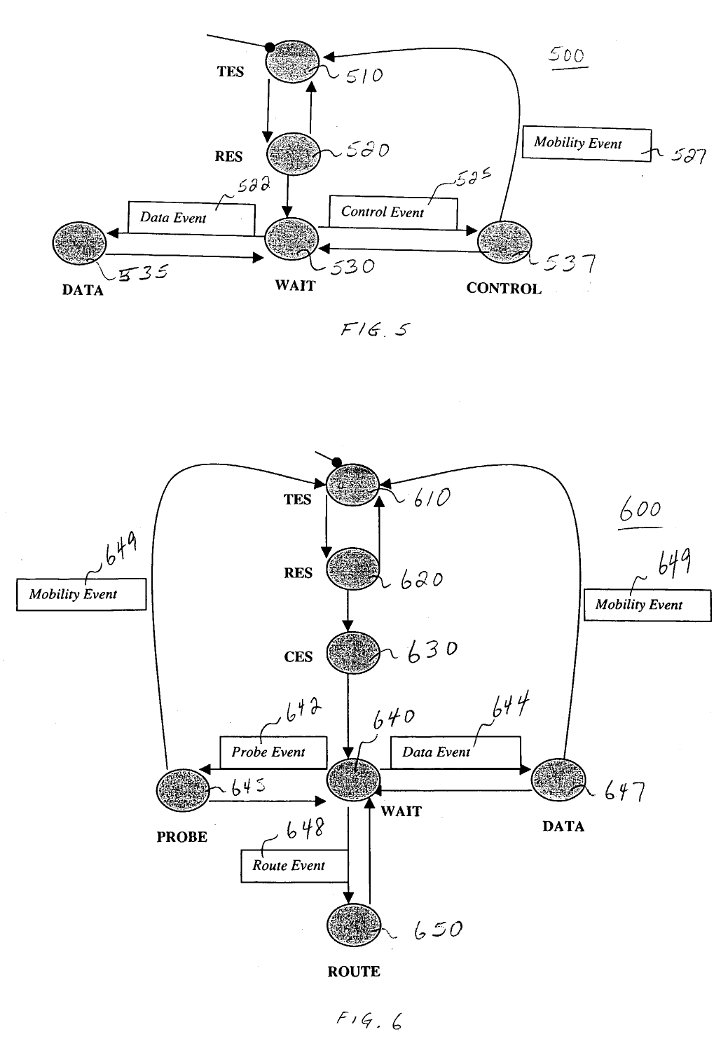

FIG. 5 illustrates a flowchart of a method 500 for operating a control node of the present invention. More specifically, FIG. 5 illustrates the various states of a control node relative to various type of events.

In one embodiment, a control node can be in five different states. These are the topology establishment state, the route establishment state, the wait state, the data state and the control state.

In the topology establishment state of step 510, the control node establishes its neighborhood or “piconet”. The piconet consists of the immediate neighbors of the control node. The control node establishes the piconet using an Inquiry (and Page) process. There are two parameters that control the inquiry process: 1) the inquiry duration and 2) the inquiry period. The duration determines how long the inquiry process should last and the period determines how frequently the inquiry process must be invoked.

For example, when a neighbor is discovered, an appropriate connection to that neighbor is established. The inquiry (page) scan process allows neighboring nodes to discover the control node. Once the topology establishment state terminates, the control node transits to the route establishment state.

In the route establishment state of step 520, the control node responds to any route request messages and transmits route information in a route reply message to every neighbor. It then transits back to the topology establishment state. The TES-RES cycle terminates either manually or after a fixed number of tries. The control node enters the wait state after the TES-RES cycle terminates.

In the wait state of step 530, the control node waits for three events: a data event 522, a mobility event 527 or a control event 525. The control node transits to a data state, a topology establishment state or a control state depending on the event that occurs in the wait state. A data event 522 occurs when the control node receives sensor data. A mobility event 527 occurs when there is a change in the location of the control node. A control event 525 occurs when the control node must probe one or more sensor node(s).

The control node reaches the data state from a wait state after the occurrence of a data event. In this state, the control node processes any incoming data and sends an ACK protocol data unit (PDU) to the immediate neighbor that delivered the data. At this point, the control node reverts back to the wait state.

The control node reaches the control state from the wait state after the occurrence of a control event. A control event occurs when the control node must probe a sensor to set or get parameters. A control event may occur synchronously or asynchronously. In this state, the control node assembles an appropriate PDU and sends it to the destination sensor node. At the application layer, the control node expects an (ACK) from the destination sensor node. At the link layer, the control node expects an acknowledgement (ACK) PDU from the immediate neighbor who received the probe PDU for transmission to the destination sensor. If no ACK arrives within a specified time, the probe PDU is re-transmitted. The control node may attempt re-transmission of probe PDU several times (perhaps trying alternative routes). If the control node does not receive an ACK PDU, the control node moves into the topology establishment state to re-establish its neighborhood. It performs this function on the assumption that one or more neighboring nodes may have changed location.

After re-establishing its piconet and routing information, the control node moves back into the wait state. Note that the control node removes an element from its probe queue only after receiving an ACK PDU. In the wait state, a control event 525 is immediately triggered since the probe queue is not empty. The control node then reverts into the control state and transmits the unacknowledged probe PDU.

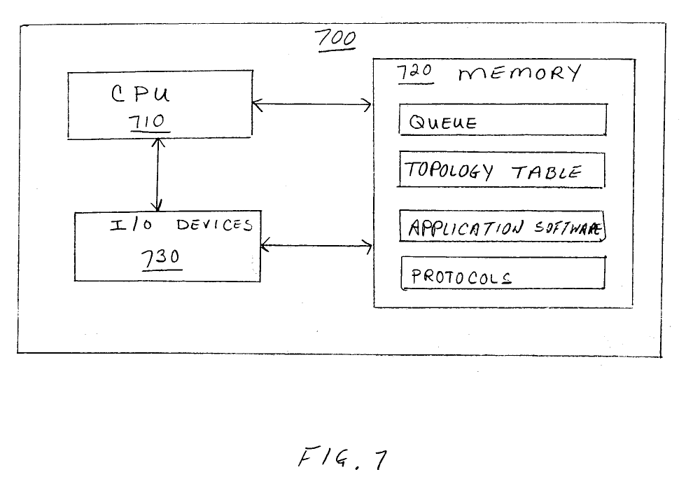

FIG. 6 illustrates a flowchart of a method 600 for operating a sensor node of the present invention. More specifically, FIG. 6 illustrates the various states of a sensor node relative to various type of events.

In one embodiment, the sensor node can be in seven states. These are the topology establishment state, route establishment state, credentials establishment state, wait state, data state, probe state and route state.

In the topology establishment state of step 610, the sensor (or relay) node sets up the mechanism to participate in a piconet. It attempts to participate in a piconet using the Inquiry Scan (and Page Scan) processes. There are two parameters that control the inquiry process: the inquiry scan duration and the inquiry scan period. The duration determines how long the inquiry scan process should last and the period determines how frequently the inquiry scan process must be invoked. The sensor node also attempts to determine its neighbors using the inquiry and page processes. Upon establishment of the piconet, the sensor node reverts to the route establishment state.

In the route establishment state of step 620, the sensor (or relay) node establishes route(s) to the control node(s) and passes routing information in a route reply message to its immediate neighbors upon receiving route request messages. A route reply message is a response to a route request message generated by the sensor/relay node. As described in the sensor deployment scenario, the sensor node continues in a TES-RES cycle until it terminates. Upon completion of the TES-RES cycle, the sensor node moves into the credentials establishment state of step 630, whereas a relay node enters the wait state.

In the credential establishment state of step 630, the sensor node originates a credentials message to the control node. In one embodiment, the credentials message contains information that describes the sensor type, configurable parameters and other device characteristics. The sensor then transits to the wait state.

In the wait state of step 640, the sensor node waits for four events: a sensor data event 644, a probe receipt event 642, a mobility event 649 or a route event 648. The sensor node transits to a data state 647, a probe state 645 or a topology establishment state 610 depending on the event that occurs in the wait state. A sensor data event (DE) 644 occurs when the sensor node receives sensor data or must send sensor data. A probe receipt event (PE) 642 occurs when the sensor receives a probe message from the control node. A mobility event (ME) 649 occurs when there is a change in the location of the sensor node.

A mobility event is detected when an expected ACK for a transmitted PDU does not arrive. A detection of this event causes the sensor node to transit to the topology establishment state.

A route event 648 occurs when a node receives an unsolicited route reply message. The control node originates the unsolicited route reply message when it changes location.

The sensor node reaches the data state 647 from a wait state 640 after the occurrence of a data event 644. The sensor node may send or receive data. If data is to be sent to the control node, then it assembles the appropriate PDU and sends the data to the control node. The sensor node expects an acknowledgement (ACK) PDU from the immediate neighbor that received the sensor data. If no ACK arrives within a specified time, the sensor node assumes a mobility event 649, and transits to the topology establishment state. After successful establishment of topology, routes and credentials, the sensor node transits to the wait state 640. It should be noted that the sensor node removes an element from its data queue only after receiving an ACK PDU. In the wait state, a data event is immediately triggered since the data queue is not empty. The sensor node then reverts into the data state 647 and re-transmits the unacknowledged sensor PDU. If data is to be received (the probe message), the sensor node processes the incoming data. At this point the sensor node reverts back to the wait state 640.

The sensor node enters the probe state 645 from the wait state 640 when a probe receipt event occurs. The sensor node takes the appropriate action and transmits a response ACK PDU. If the probe receipt calls for sensor information, the sensor transmits the data and expects an ACK PDU from its neighbor. It transits to the TES-RES cycle as disclosed above if no ACK is received. It then transits to the wait state 640. It should be noted that the sensor node removes an element from its probe response queue only after receiving an ACK PDU. In the wait state, if the probe response queue is non-empty, a probe receipt event is triggered and the requested probe response is re-transmitted. The sensor node then reverts to the wait state.

The sensor (or relay) node enters the route state 650 from the wait state when it receives an unsolicited route reply message from a neighbor node. This unsolicited route reply message originates from the control node when the control node changes location. In this state, the sensor (or relay) node updates its route to the originating control node and forwards the route reply message to its neighbors. The node then reverts back to the wait state.

It should be noted that the inquiry scan process is implicit in the wait state of all nodes. Otherwise, nodes can never be discovered.

It should be noted that a node may have more than one route to the control node(s). Route selection may be based on some optimality criteria. For example, possible metrics for route selection can be the number of hops, route time delay and signal strength of the links. It should be noted that when a mobility event occurs, the new route to the control node may not be optimal in terms of number of hops. Computing optimal routes (using number of hops as a metric) involves indicating to the control node that a mobility event has occurred and re-initiating the TES-RES cycle across the network nodes. This approach may consume considerable power and also may increase the probability of detection. In one embodiment, it is preferred not to broadcast routing messages to obtain optimal number of hops, which will, consume battery power and enhance the probability of detection.

It should be noted there is no intrinsic limitation on the number of nodes that may be deployed in the sensor network of the present invention. Nor is there any intrinsic limitation on the number of nodes that may participate in a piconet. Although the current Bluetooth implementations limit the size of a neighborhood (piconet) to eight nodes, the present invention is not so limited.

It should be noted that low rate topological changes in the network topology are addressed via the mobility event and route event. Network topology may change either due to change in location of nodes or due to malfunctioning nodes. All nodes may try alternative routes before indicating a mobility event. Alternative paths may be sub-optimal in terms of the number of hops, but it may be optimal in terms of packet delivery delay. If no alternative paths exist, the node will indicate a mobility event.

It should be noted that the deployment of a queue in a node provides an important function, e.g., storing messages that need to be retransmitted. Namely, retransmission of sensor and control data ensures reliable delivery.

Additionally, it should be noted that all nodes remain silent (except for the background inquiry scan process) unless an event occurs. This minimizes power consumption and minimizes the probability of detection.

Finally, the present system is not constrained by the physical layer protocol. The above methods and protocols may be implemented over Bluetooth, 802.11 B, Ultra Wide Band Radio or any other physical layer protocol.

FIG. 7 illustrates a block diagram of a general purpose computing system or computing device 700 implementing a network node of the present invention. Namely, any of the network nodes described above can be implemented using the general purpose computing system 700. The computer system 700 comprises a central processing unit (CPU) 710, a system memory 720, and a plurality of Input/Output (I/O) devices 730.

In one embodiment, novel protocols, methods, data structures and other software modules as disclosed above are loaded into the memory 720 and are operated by the CPU 710. Alternatively, the various software modules (or parts thereof) within the memory 720 can be implemented as physical devices or even a combination of software and hardware, e.g., using application specific integrated circuits (ASIC), where the software is loaded from a storage medium, (e.g., a magnetic or optical drive or diskette) and operated by the CPU in the memory 720 of the computer. As such, the novel protocols, methods, data structures and other software modules as disclosed above or parts thereof can be stored on a computer readable medium, e.g., RAM memory, magnetic or optical drive or diskette and the like.

Depending on the implementation of a particular network node, the I/O devices include, but are not limited to, a keyboard, a mouse, a display, a storage device (e.g., disk drive, optical drive and so on), a scanner, a printer, a network interface, a modem, a graphics subsystem, a transmitter, a receiver, one or more sensors (e.g., a global positioning system (GPS) receiver, a temperature sensor, a vibration or seismic sensor, an acoustic sensor, a voltage sensor, and the like). It should be noted that various controllers, bus bridges, and interfaces (e.g., memory and I/O controller, I/O bus, AGP bus bridge, PCI bus bridge and so on) are not specifically shown in FIG. 7. However, those skilled in the art will realize that various interfaces are deployed within the computer system 700, e.g., an AGP bus bridge can be deployed to interface a graphics subsystem to a system bus and so on. It should be noted that the present invention is not limited to a particular bus or system architecture.

For example, a sensor node of the present invention can be implemented using the computing system 700. More specifically, the computing system 700 would comprise a Bluetooth stack, a routing protocol (may include security and quality of service requirements), and an intelligent sensor device protocol. The protocols and methods are loaded into memory 720.

Although various embodiments which incorporate the teachings of the present invention have been shown and described in detail herein, those skilled in the art can readily devise many other varied embodiments that still incorporate these teachings.

What is claimed is:

1. A sensor system having a plurality of nodes, comprising:
at least one sensor for detecting a sensor event;
a sensor node for interfacing with said at least one sensor to receive said sensor event; and
a control node for receiving said sensor event from said sensor node via a route through a plurality of nodes.

2. The sensor system of claim 1, wherein said sensor node remains in a wait state until said sensor event is received from said at least one sensor.

3. The sensor system of claim 1, wherein said at least one sensor comprises a global position system receiver, a temperature sensor, a voltage sensor, a vibration sensor, or an acoustic sensor.

4. The sensor system of claim 1, further comprising a relay node, wherein said relay node forms a part of said route, for passing said sensor event from said sensor node to said control node.

5. The sensor system of claim 1, where said control node is a gateway node for communicating with a wide area network (WAN).

6. The sensor system of claim 5, wherein said wide area network is a wireless wide area network.

7. The sensor system of claim 4, further comprising:
a bridge node for connect two sub-networks, where said control node is located in a first sub-network and said sensor node is in a second sub-network, and wherein said bridge node forms a part of said route.

8. The sensor system of claim 7, wherein said two sub-networks have different bandwidth.

9. The sensor system of claim 1, wherein said nodes with the sensor system are self-organizing.

10. The sensor system of claim 1, wherein said nodes with the sensor system are self-healing.

11. A method for establishing a network node within a sensor system, where said sensor system comprises consumer and producer nodes, said method comprising the steps of:
a) activating a consumer node;
b) sending a message by said consumer node to its neighbor nodes, where said message identifies presence of said consumer node;
c) propagating said message by each of said neighbor nodes to all nodes within the sensor system; and
d) recording a route to said consumer node by each node within the sensor system.

12. The method of claim 11, further comprising the step of:
e) forwarding a message by a producer node to said consumer node, wherein said message describes parameters of said producer node.

13. The method of claim 12, wherein said message includes a sensor type or a listing of configurable parameters.

14. The method of claim 11, further comprising the step of:
e) forwarding a message by a producer node to said consumer node, wherein said message acknowledges the presence of said consumer node.

15. The method of claim 14, wherein said producer node enters a wait state, and will exit said wait state when one of the following events is detected: a sensor data event, a probe receipt event, a mobility event or a route event.

16. A method for establishing a network node within a sensor system, where said sensor system comprises consumer and producer nodes, said method comprising the steps of:
a) activating a producer node;
b) placing said producer node into a wait state, wherein said producer node waits for a message to indicate that a route is available to a consumer node.

17. The method of claim 16, further comprising the step of:
c) sending a message by said producer node to its neighbor nodes to participate in a piconet.

18. The method of claim 17, further comprising the step of:
d) establishing a route to said consumer node.

19. The method of claim 18, further comprising the step of:
e) sending a credential message to said consumer node to identify characteristics of said producer node to said consumer node.

20. The method of claim 19, further comprising the step of:
f) causing said producer node to enter a wait state.
